(19) United States
(12) Patent Application Publication
(10) Pub. No.: US 2018/0094960 A1
(43) Pub. Date: Apr. 5, 2018

(54) MODULAR WATER METER BOX

(71) Applicant: GEOSPACE TECHNOLOGIES CORPORATION, Houston, TX (US)

(72) Inventors: Jeff A. COOK, Houston, TX (US); David ZOCH, Houston, TX (US)

(73) Assignee: GEOSPACE TECHNOLOGIES CORPORATION, Houston, TX (US)

(21) Appl. No.: 15/284,079

(22) Filed: Oct. 3, 2016

(51) Int. Cl. G01F 15/14

(52) U.S. Cl. CPC G01F 15/14

(57) ABSTRACT

A modular water meter box includes a plurality of water meter side modules. Each water meter side module includes a first end, a second end, a top side, and bottom side. The first end is configured for detachable connection to a first different box side module. The second end is configured for detachable connection to a second different box side module. The bottom side is thicker than the top side.

### BACKGROUND

Where services such as gas, electricity or water are supplied to a budding or other geographic area, meters and associated systems are commonly installed to measure utility usage. The meters are typically located in cases to protect them from weather and/or tampering. The meters are sometimes located inside of or beneath buildings. Meters may also be located in exterior meter boxes. In many locations it is desirable to position water meters outside of the structure to which water is being provided. Thus, the water meter is often positioned in a location where the meter cannot be damaged by inadvertently striking or otherwise deforming the meter. It is therefore customary to position the water meter below ground level. By positioning the water meter below ground level, in the situation where the water meter is utilized to measure the amount of water provided to a structure or area, the water meter can be positioned below the freezing level of the ground. The bottom of the water meter box may be left open so that water leaking from the water meter can pass into and be absorbed by the soil beneath and around the meter. Water meter boxes must be made sufficiently strong to withstand the pressure of the surrounding soil.

### SUMMARY

A modular water meter box is disclosed herein. In one embodiment, a water meter box for protecting a water meter disposed below ground includes a first side part, a second side part, a first end part, and a second end part. A first end of the first side part is detachably connectable to a second end of the first end part. A second end of the first side part is detachably connectable to a first end of the second end part. A second end of the second side part is detachably connectable to a first end of the first end part. A first end of the second side part is detachably connectable to a second end of the second end part. Each of the first side part, second side part, first end part, and second end part comprises a port for passing a pipe between an exterior and an interior of the water meter box.

In another embodiment, a water meter box side module includes a first end, a second end, a top side, and a bottom side. The first end is configured for detachable connection to a first different box side module. The second end is configured for detachable connection to a second different box side module. The bottom side is thicker than the top side.

In a further embodiment, a water meter box includes a plurality of side modules. Each of the side modules engages two other of the side modules via locking tabs and locking apertures of the side modules. Each of the side modules includes a first end, a second end, a top side, a bottom side, and a wall extending from the first end to the second end and from the top side to the bottom side. The first end includes a plurality of locking tabs extending axially from an end wall surface. Each of the locking tabs includes a base portion and a hook portion. The base portion extends axially from the end wall surface. The hook portion extends normally from the base portion. The hook portion includes a locking notch in side of the hook portion nearest the end wall surface. The second end includes a plurality of apertures and a plurality of locking projections. The apertures extend through the side module with spacing corresponding to the locking tabs. Each of the locking protrusions corresponds to one the apertures, and is configured to engage a locking tab of one of the two other of the side modules. The bottom side is thicker than the top side. The wall includes horizontal ridges, horizontal ribs, vertical ribs, and a mounting groove. One of the horizontal ribs extends from an exterior apex of each of the horizontal ridges along an entire length of the apex. The vertical ribs extend along an entire height of the side module. The mounting groove is to retain a wireless communication system in an interior surface of the wall.

### BRIEF DESCRIPTION OF THE DRAWINGS

For a detailed description of exemplary embodiments, reference will now be made to the accompanying drawings, in which:

FIG. 1 shows an isometric view of a water meter box assembly in accordance with principles disclosed herein;

FIG. 2 shows two water meter box modules arranged for assembly in accordance with principles disclosed herein;

FIG. 3 shows two water meter box modules constructively engaged in accordance with principles disclosed herein;

FIGS. 4A-4D show views of a first embodiment of a water meter box module in accordance with principles disclosed herein;

FIG. 5A-5E show views of a first embodiment of a water meter box module in accordance with principles disclosed herein; and

FIGS. 6A and 6B shows horizontal cross-sectional views of a first embodiment of a water meter box module in accordance with principles disclosed herein; and

FIG. 7 shows views of a second embodiment of a water meter box module in accordance with principles disclosed herein.

### NOTATION AND NOMENCLATURE

In the following discussion and in the claims, the terms “including” and “comprising” are used in an open-ended fashion, and thus should be interpreted to mean “including, but not limited to . . . ”. Any use of any form of the terms “connect,” “engage,” “couple,” “attach,” or any other term describing an interaction between elements is intended to mean either an indirect or a direct interaction between the elements described. The recitation “based on” is intended to mean “based at least in part on.” Therefore, if X is based on Y, X may be based on Y and any number of additional factors.

When introducing elements of various embodiments of the present invention, the articles “a,” “an,” “the,” and “said” are intended to mean that there are one or more of the elements. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience, but does not require any particular orientation of the components.

### DETAILED DESCRIPTION

In the drawings and description of the present disclosure, like parts are typically marked throughout the specification and drawings with the same reference numerals. The drawing figures are not necessarily to scale. Certain features of the invention may be shown exaggerated in scale or in somewhat schematic form, and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings and components of the embodiments discussed below may be employed separately or in any suitable combination to produce desired results.

A substantial portion of the cost of a water meter box results from the cost of shipping the water meter box from the location of manufacture to the location of installation, and storage of the water meter box prior to installation. Conventional water meter boxes are manufactured as unitary structures having of an outer wall surrounding an open interior. Unfortunately, such a configuration is space inefficient, and therefore relatively costly, to ship and store because of the space wasted by the open interior of the box. The water meter box disclosed herein may also be substantially lighter than conventional water meter boxes to further reduce shipping costs. For example, some conventional water meter boxes are made of concrete, while the modular water meter box disclosed herein is formed of a polymer, such as polypropylene, and therefore may be only a fraction of the weight of a conventional concrete meter box.

Because the size of the water meter box needed for any particular application can vary widely, conventional water meter boxes are manufactured in a variety of sizes. For example, a smaller water meter box may be needed to house a single water meter, and a larger water meter box may be needed to house multiple co-located water meters. Shipping and storage of conventional water meter boxes of different sizes may increase the costs associated with the box.

Embodiments of the water meter box disclosed herein are of modular construction. Accordingly, the water meter box of the present disclosure may be shipped and stored as pieces that occupy substantially less space than conventional water meter boxes, and may therefore be substantially less costly to ship and store than conventional water meter boxes. For example, the water meter box side modules disclosed herein may be stackable to effectively allow many more (e.g., 3 times more) water meter boxes to be shipped and stored per pallet than is possible with conventional water meter boxes. Additionally, the modular construction of the water meter boxes disclosed herein allows for assembly of multiple sizes of the water meter box while storing only a few sizes of meter side modules. For example, three different sizes of the water meter box can be produced from two sizes of the water meter box side modules. As a result, the modular water meter box further promotes efficiency in shipping and storage by reducing the number of components that must be shipped and stored to support different meter box sizes.

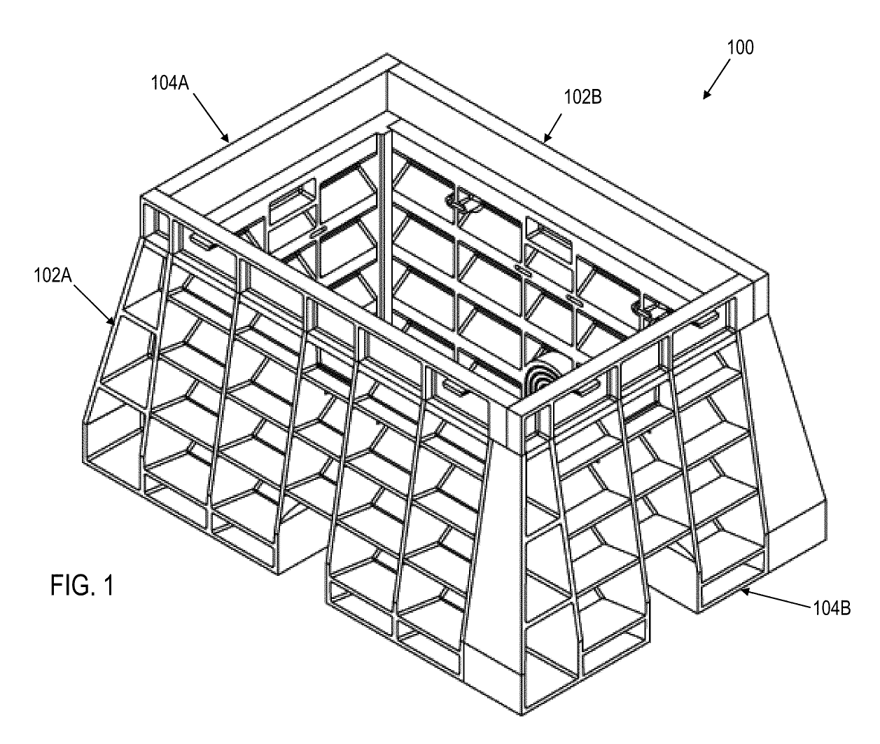

FIG. 1 shows an isometric view of a water meter box 100 in accordance with principles disclosed herein. The water meter box 100 is formed of four side modules (i.e., four side parts) that mechanically engage one another to form a rigid structure. The water meter box 100 includes side modules 102A and 102B (i.e., side modules 102), and side modules 104A and 104B (i.e., side modules 104). The side modules 102A and 102B are identical to each other, and the side modules 104A and 104B are identical to each other. The side modules 102 may be generally similar or identical to the side modules 104, but differ in length from the side modules 104. Each of the side modules 102A, 102B, 104A, and 104B is mechanically interlocked to the two adjacent and normally disposed side modules. For example, side module 102A is mechanically interlocked to the side modules 104A and 104B, side module 102B is mechanically interlocked to the side modules 104A and 104B, side module 104A is mechanically interlocked to the side modules 102A and 102B, and side module 104B is mechanically interlocked to the side modules 102A and 102B.

The side modules 102 and 104 may be shipped and/or stored separately, and interlocked to form the water meter box 100 at an installation site or at an installation staging site, thereby reducing the shipping and storage volume of the water meter 100, and correspondingly reducing the cost associated with shipping and storage of the water meter box 100. Because the side modules 102 and 104 are interlocked to form the water meter box 100, water meter boxes 100 of three different sizes may be constructed using the side modules 102 and 104. For example, four side modules 104 may be interlocked to form a small water meter box 100, two side modules 102 may be interlocked with two side modules 104 to form a medium water meter box 100, or four side modules 102 may be interlocked to form a large water meter box 100. The side modules 102, 104 may be provided with any dimensions needed to form a suitable water meter box 100. Various additional features of the water meter box 100 and the side modules 102, 104 are described herein.

The side modules 102 and 104 may be interlocked by any of a variety of fastening methods. Interlocking via tabs and slots of each side module is described herein with respect to some embodiments. Other embodiments may be interlocked using screws, bolts, pins, knuckles of the side modules 102/104 and bolts or pins similar to those used in hinges, adhesives, or other fasteners.

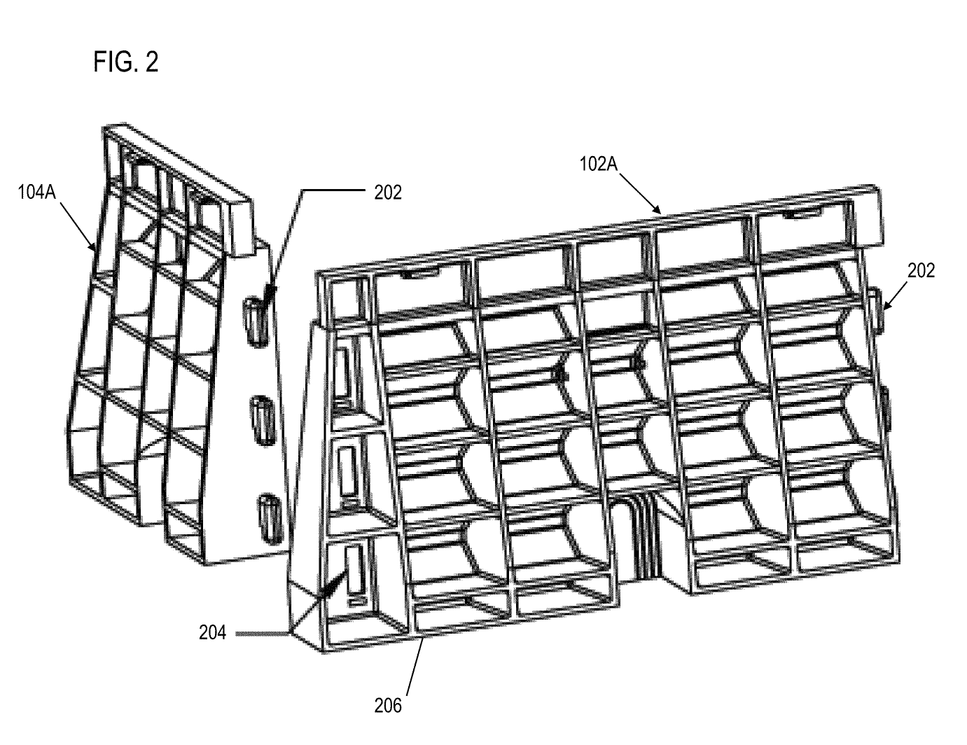

FIG. 2 shows water meter box side module 102A and water meter box side module 104A arranged for assembly in accordance with principles disclosed herein. Each of the side modules 102, 104 includes multiple locking tabs 202 that extend axially from a first end of the side module, and includes multiple locking apertures or slots 204 that extend through a wall at a second end of the side module 102, 104, and have spacing corresponding to the distance separating the locking tabs 202. The locking tabs 202 of the side module 104A are inserted through the locking slots 204 of the side module 102A and shifted towards the base 206 of the side module 102A to engage the side module 102A and mechanically interlock the side modules 102A and 104A. All four of the side modules 102, 104 are interlocked in this manner to form the water meter box 100. The locking tabs 202 and locking slots 204 may be of any of a variety of shapes suitable for securing together the side modules 102 and 104.

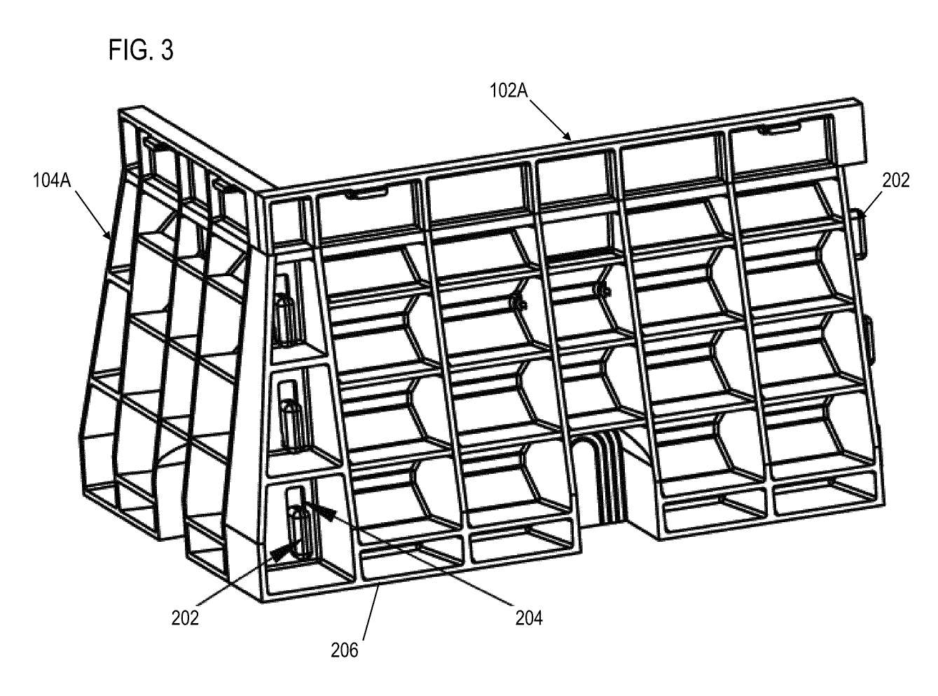

FIG. 3 shows the water meter box side module 102A and water meter box side module 104A mechanically interlocked using the locking tabs 202 and the locking slots 204. The locking tabs 202 of the side module 104A have been inserted through the locking slots 204 of the side module 102A and shifted towards the base 206 of the side module 102A to engage the side module 102A and mechanically interlock the side modules 102A and 104A.

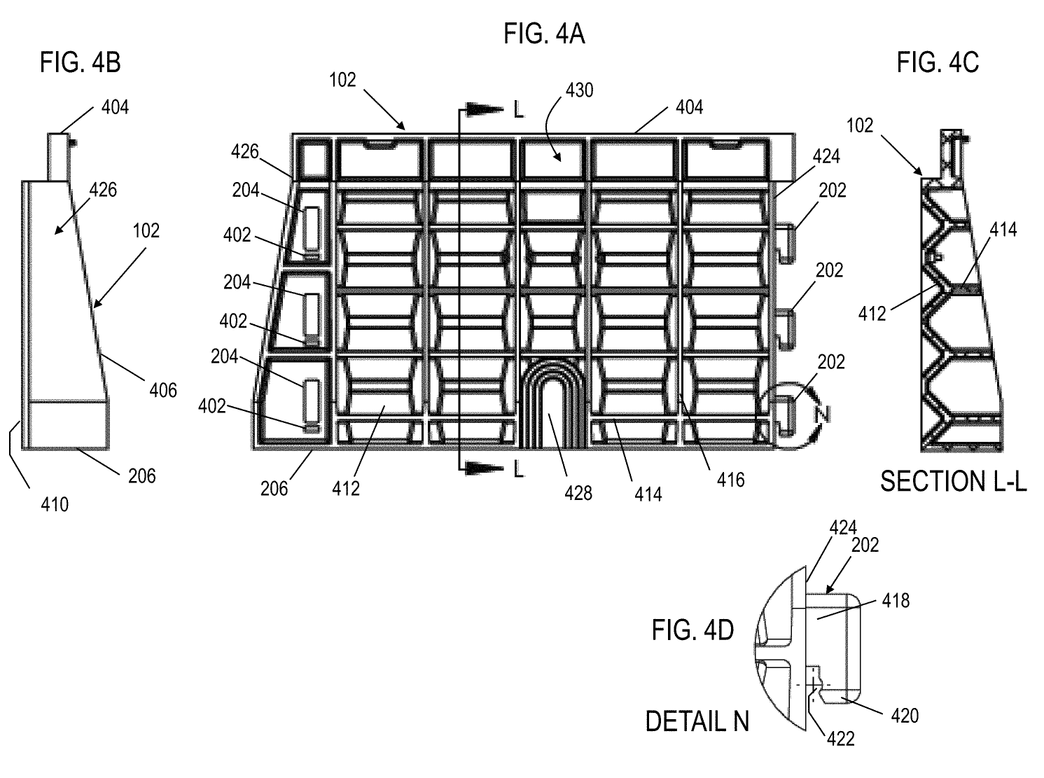

FIGS. 4A-4D show views of the side module 102 of a water meter box side module in accordance with principles disclosed herein. FIG. 4A shows a side view of the exterior of the side module 102. FIG. 4B shows an end view of the side module 102. FIG. 4C shows a vertical cross sectional view L-L of the side module 102. FIG. 4D shows detail of the latching tab 202. Each feature explained with regard to the side module 102 is also found in the side module 104. As noted herein, the side modules 102 and 104 may differ only in length. The side module 102 includes a top side 404, a base side 206, a tab side 424, and a slot side 426. The locking tabs 202 extend axially from an outer surface of the tab side 424, and the locking slots 204 pass through the wall of the side module 102 (from interior to exterior) proximate the slot side 426. The side module 102 includes a locking protrusion 402 corresponding to each of the locking slots 204. The locking projection 402 is positioned to engage the locking tab 202 inserted through the locking slot 204 when the locking tab 202 is shifted towards the base 206 of the side module 102.

Referring now to FIG. 4D, additional detail of the locking tab 202 is shown. The locking tab 202 includes a base portion 418 that extends from the tab side 424, and a hook portion 420 that extends from the base portion 418 and is parallel to the tab side 424. The hook portion 420 includes a locking notch 422 in the surface of the hook portion 420 nearest the tab side 424. The locking notch 422 is positioned to receive and engage the locking projection 402 when the locking tab 202 is inserted through the locking slot 204 and shifted towards the base 206, thereby locking the latching tab 202 in place, and securing the side module 102 to the side module 104.

FIG. 4B shows that the profile of the side module 102 is generally that of a right trapezoid. That is, the inside edge 410 is perpendicular to the base 206, and the outside edge 406 is acute to the base 206. Accordingly, the thickness of the side module 102 increases with proximity to the base 206, and the base 206 is thicker than the top side 404.

As a result of the right trapezoidal shape of the side modules 102, 104, the base of the water meter box 100 is wider than the top of the water meter box 100 as can be best seen in FIG. 1. When the water meter box 100 is surrounded by soil, the generally trapezoidal shape anchors the water meter box 100 into the ground, and prevents the water meter box 100 from floating out of the ground. Some embodiments of the side modules 102, 104 may be formed (e.g., cast) of polypropylene, which is lighter than water, and thus may float in water if not anchored into the ground.

As shown in FIGS. 4A and 4C, the side wall 430 of the side module 102 is corrugated to include horizontal ridges/furrows, waves, or undulations 412. The corrugation increases the strength of the side module 102. A horizontal rib 414 extends from the apex of each ridge 412 on the external side of the wall 430. The horizontal ribs 414 increase in width (i.e., width is length of extension from the apex of the ridge 412) with proximity to the base 206. That is, the horizontal ribs 414 nearer the base 206 are wider than the horizontal ribs 414 farther from the base 206. When the water meter box 100 is installed, soil may enter the space between the ribs 414 to anchor the water meter box 100 in the ground. Thus, the horizontal ribs 414 enhance the overall structure of the water meter box 100 to ensure that the water meter box 100 is securely anchored in the ground. The side module 102 also includes vertical ribs 416 that extend from the top side 404 to the base 206, and are perpendicular to the top side 404 and the base 206. The vertical ribs 416 intersect the horizontal ribs 414. The intersecting vertical ribs 416 and horizontal ribs 414 enhance the strength of the side module 102, while allowing for impaction of soil in the spaces between the ribs 414, 416 to improve in-ground stability.

The side module 102 includes a port 428 that allows piping (i.e., one or more water pipes) to pass into or out of the water meter box 100 through the side module 102. The port 428 may provide selectable sizing to accommodate various diameters of piping. For example, the port 428 may include scoring that allows various amounts of material of the wall 430 to be removed from the side module 102 as needed to provide adequate clearance for specific piping. The port 428 may include concentric knock-outs of increasing diameter, where knock-outs are pre-scored sections of wall material that are removable at installation time as needed.

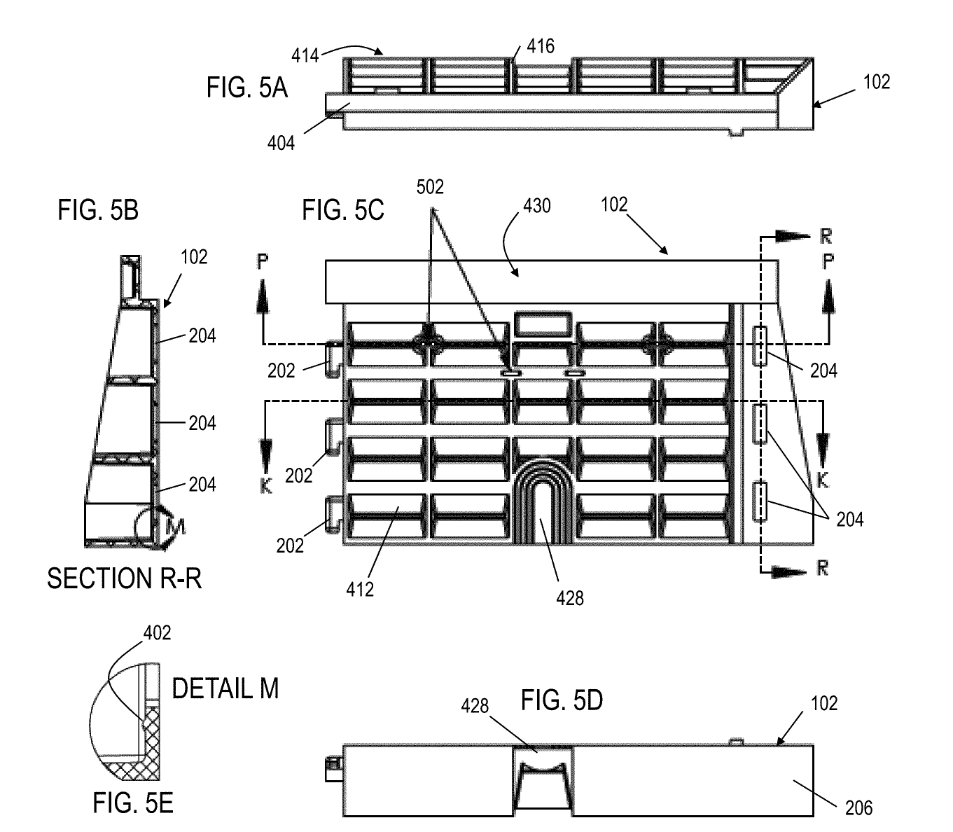

FIGS. 5A-5E show views of the side module 102 of a water meter box side module 102 in accordance with principles disclosed herein. FIG. 5A shows a top view of the side module 102. FIG. 5B shows a vertical cross-sectional view R-R of the side module 102. FIG. 5C shows a front view of the interior of the side module 102. FIG. 5D shows a bottom view of the side module 102. FIG. 5E shows detail of area M of the vertical cross-sectional view R-R of FIG. 5B.

Water meter flow measurements may be wireless communicated to a reader via a wireless communication system coupled to the water meter. Referring to FIG. 5C, the interior of the wall 430 includes mounting grooves 502 to receive and retain a wireless communication system (automated meter reading (AMR) or advanced metering infrastructure (AMI) hardware) coupled to the water meter housed within the water meter box 100. The mounting grooves 502 may receive and retain any of wide variety of AMR and/or AMI devices either directly or via mounting brackets adapted for use with the grooves 502. To further facilitate the use of AMR/AMI systems, the side modules 102 and 104 are formed of a radio frequency friendly material such as polypropylene.

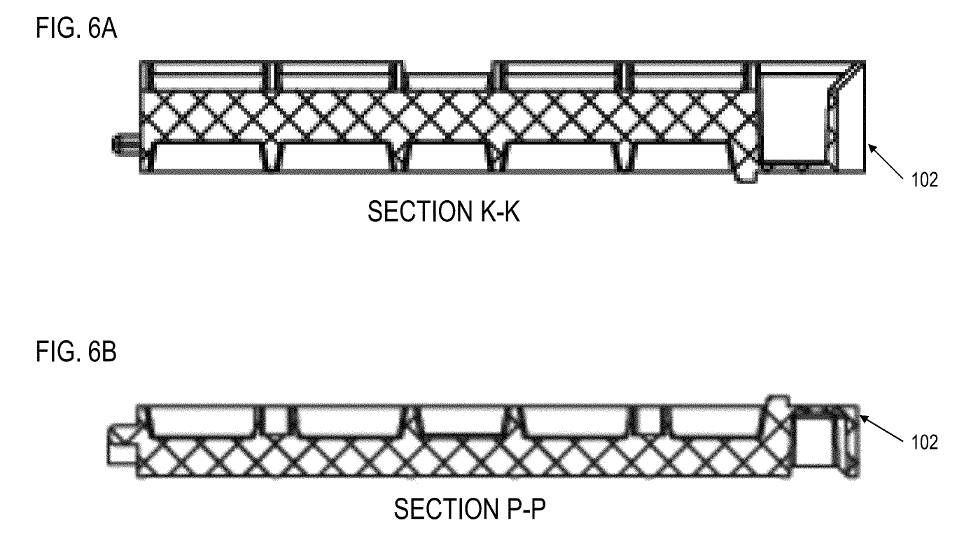

FIG. 6A and 6B shows horizontal cross-sectional views of a water meter box side module 102 in accordance with principles disclosed herein. FIG. 6A shows a horizontal cross-sectional view K-K of the side module 102 as viewed from the top of the side module 102 and as shown in FIG. 5C. FIG. 6B shows a horizontal cross-sectional view P-P of the side module 102 as viewed from the bottom of the side module 102 and as shown in FIG. 5C.

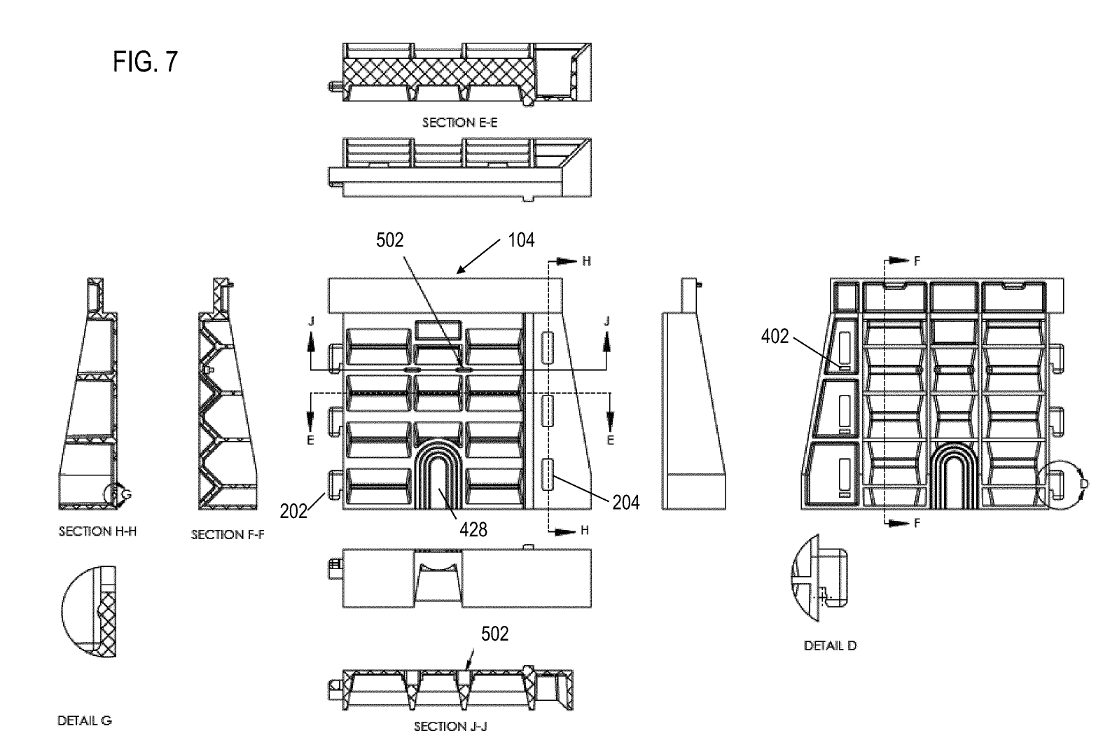

FIG. 7 shows views of a water meter box side module 104 in accordance with principles disclosed herein. The water meter side module 104 is an embodiment of the water meter side module 102 described herein and may include all the features described herein with respect to the water meter side module 102.

The above discussion is meant to be illustrative of various principles and embodiments of the present disclosure. While certain embodiments have been shown and described, modifications thereof can be made by one skilled in the art without departing from the spirit and teachings of the disclosure. The embodiments described herein are exemplary only, and are not limiting. Accordingly, the scope of protection is not limited by the description set out above, but is only limited by the claims which follow, that scope including all equivalents of the subject matter of the claims.

What is claimed is:

1. A water meter box for protecting a water meter disposed below ground, the water meter box comprising:
a first side part;
a second side part;
a first end part; and
a second end part;
wherein:
a first end of the first side part is detachably connectable to second end of the first end part;
a second end of the first side part is detachably connectable to a first end of the second end part;
a second end of the second side part is detachably connectable to a first end of the first end part;
a first end of the second side part is detachably connectable to a second end of the second end part; and
each of the first side part, second side part, first end part, and second end part comprises a port for passing a pipe between an exterior and an interior of the water meter box.

2. The water meter box of claim 1, wherein the first end of each of the first side part;
the second side part; the first end part; and the second end part comprises a plurality of locking tabs extending axially from the part.

3. The water meter box of claim 2, wherein the second end of each of the first side part; the second side part; the first end part; and the second end part comprises a plurality of apertures, wherein each of the apertures is sized to pass one of the locking tabs through the part.

4. The water meter box of claim 2, wherein each of the locking tabs comprises:
a base portion extending axially from the part;
a hook portion extending normally from the base portion; and
a locking notch in an inner side of the hook portion.

5. The water meter box of claim 4, wherein the second end of each of the first side part; the second side part; the first end part; and the second end part comprises a locking projection to engage the locking notch.

6. The water meter box of claim 1, wherein each of the first side part, the second side part, the first end part, and the second end part comprises a top side and a base side that is thicker than a top side, where thickness is measured as distance from an interior to an exterior of the part.

7. The water meter box of claim 1, wherein a wall of each of the first side part; the second side part; the first end part; and the second end part is corrugated and comprises a plurality of ridges and furrows.

8. The water meter box of claim 7, wherein the wall of each of the first side part; the second side part; the first end part; and the second end part comprises first ribs extending from an apex of each ridge horizontally along an entire length of the apex, and second ribs extending vertically from a top side to a base side of the part.

9. The water meter box of claim 1, wherein an interior surface of each of the first side part; the second side part; the first end part; and the second end part comprises a mounting groove to retain a wireless communication system.

10. The water meter box of claim 1, wherein each of the first side part; the second side part; the first end part; and the second end part is approximately right trapezoidal in profile.

11. A water meter box side module, comprising:
a first end configured for detachable connection to a first different water meter box side module;
a second end configured for detachable connection to a second different water meter box side module;
a top side; and
a base side, wherein the base side is thicker than the top side.

12. The water meter box side module of claim 11, wherein the first end comprises a plurality of locking tabs extending axially from a wall surface of the first end.

13. The water meter box side module of claim 12, wherein the second end comprises a plurality of apertures extending through the module with spacing corresponding to the locking tabs.

14. The water meter box side module of claim 12, wherein each of the locking tabs comprises:
a base portion extending axially from the wall surface of the first end;
a hook portion extending normally from the base portion; and
a locking notch in an inner side of the hook portion.

15. The water meter box side module of claim 14, wherein the second end comprises a plurality of locking protrusions, each of the locking protrusions configured to engage the locking notch of one of the locking tabs of the second different water meter box side module.

16. The water meter box side module of claim 14, further comprising a wall surface comprising a plurality of undulations.

17. The water meter box side module of claim 16, further comprising horizontal ribs extending from an exterior apex of each undulation along an entire length of the apex, and vertical ribs extending from the top side to the base side of the water meter box side module.

18. The water meter box side module of claim 15, further comprising a mounting groove to retain a wireless communication system in an interior wall surface of the water meter box side module.

19. The water meter box side module of claim 15, wherein the module is approximately right trapezoidal in profile.

20. A water meter box comprising:
a plurality of side modules, each of the side modules engaging two other of the side modules via lock tabs and locking apertures of the side modules;
wherein each of the side modules comprises:
a first end comprising a plurality of locking tabs extending axially from an end wall surface of the side module, wherein each of the locking tabs comprises:
a base portion extending axially from the end wall surface;
a hook portion extending normally from the base portion; and
a locking notch in an inner side of the hook portion;
a second end comprising:
a plurality of apertures extending through the side module with spacing corresponding to the locking tabs;
a plurality of locking protrusions, each of the locking protrusions corresponding to one the apertures, and configured to engage a locking tab of one of the two other of the side modules;
a top side;
a base side that is thicker than the top side;
a wall extending from the first end to the second end and from the top side to the bottom side, wherein the wall comprises:
a plurality of undulations;
horizontal ribs extending from an exterior apex of each undulation along an entire length of the apex;
vertical ribs extending from the top side to the base side of the side module; and
a mounting groove to retain a wireless communication system in an interior surface of the wall.
